(19) United States
(12) Patent Application Publication
(10) Pub. No.: US 2004/0236621 A1
(43) Pub. Date: Nov. 25, 2004

(54) Business context layer

(76) Inventor: Jeff Scott Eder, Mill Creek, WA (US)

Correspondence Address: JEFF EDER, 19108 30TH DRIVE SE, MILL CREEK, WA, 98012, US

(21) Appl. No.: 10/071,164

(22) Filed: Feb. 7, 2002

(51) Int. Cl. G06F 17/60

(52) U.S. Cl. 705/10

(57) ABSTRACT

A business context layer for an operating system. A market value matrix package is used to develop a business context layer for an operating system. The business context layer is propagated to all the operating systems within an enterprise or multi-enterprise organization. Internal systems, partner systems and vendor systems access the information in the layer as required to make informed decisions that benefit the entire enterprise or multi-enterprise organization.

### BACKGROUND OF THE INVENTION

This invention relates to a business context layer for an operating system. Operating systems can include operating systems for computers and other hardware, network operating systems and web service platforms.

Managing a business in a manner that creates long term value is a complex and time-consuming undertaking. This task is complicated by the fact that traditional financial and risk management systems do not provide sufficient information for managers in the Knowledge Economy to make the proper decisions. Traditional systems are also limited in their ability to support the effective management of multi-enterprise organizations like “virtual value chains” and corporations with multiple operating companies.

As illustrated in FIG. 12, the typical commercial enterprise (includes multi-enterprise organizations) contains at least 5 different segments of value:

1) the value of the current operation—the value generated by the sales from the enterprise to its customers—this includes the net value of financial assets required to support the operation;

2) the value of real options—the value of real options and contingent liabilities the enterprise has developed;

3) derivatives—the net value of the derivatives and hedge positions the enterprise owns;

4) the net value of excess financial assets—(cash, receivables, marketable securities, etc.) less any financial liabilities (debt, payables, etc.) in excess of the amount required to support the current operation; and

5) the value of market sentiment associated with the equity—the net value created by expectations and risks associated with the enterprise equity and the market.

As detailed in cross-referenced application 10/046,316 dated Jan. 16, 2002 and as illustrated in FIG. 12, the value of each of the segments of value of the enterprise are in part determined by the enterprise elements of value (i.e. brand, customer base, production equipment etc.) and by various external factors (i.e. interest rates, inflation, etc.) that can have impacts at both the element level and at the overall enterprise or organization level.

In an apparent attempt to overcome the limitations associated with traditional management systems, a staggering variety of systems have been created over the last few years to manage the elements of value, real options and risks associated with operating a modern corporation. A partial list of the different types of systems that have been created in the last few years is shown in Table 1 below.

TABLE I

| | |
|---|---|
| 1. | alliance management systems, |
| 2. | asset management systems for capital and IT assets, |
| 3. | brand management systems, |
| 4. | business intelligence systems, |
| 5. | call management systems, |
| 6. | channel management systems, |
| 7. | content management systems, |
| 8. | customer relationship management systems, |
| 9. | demand chain systems, |
| 10. | email management systems, |
| 11. | employee relationship management systems, |
| 12. | energy risk management systems, |
| 13. | engineering management systems, |
| 14. | fraud management systems, |
| 15. | incentive management systems, |
| 16. | innovation management systems, |
| 17. | intellectual property management systems, |
| 18. | investor relationship management systems, |
| 19. | knowledge management systems, |
| 20. | location management systems, |
| 21. | maintenance management systems, |
| 22. | partner relationship management systems, |
| 23. | performance management systems (for IT assets), |
| 24. | price optimization systems, |
| 25. | private exchanges, |
| 26. | product life-cycle management systems, |
| 27. | project portfolio management systems, |
| 28. | risk simulation systems, |
| 29. | sales force automation systems, |
| 30. | scorecard systems, |
| 31. | service management systems, |
| 32. | six-sigma quality management systems, |
| 33. | supplier relationship management systems, |
| 34. | support chain systems, |
| 35. | technology chain systems, |
| 36. | unstructured data management systems, |
| 37. | visitor (web site) relationship management systems, |
| 38. | weather risk management systems, |
| 39. | workforce management systems, and |
| 40. | yield management systems |

These new systems come on top of new versions of the traditional systems that most companies have had in place for some time including those shown in Table 2 below.

TABLE 2

| | |
|---|---|
| 1. | a basic financial system like a general ledger,* |
| 2. | a budgeting/financial planning system, |
| 3. | a cash management system, |
| 4. | commodity risk management systems, |
| 5. | a credit-risk management system, |
| 6. | a human resource management system,* |
| 7. | an interest rate risk management system,* |
| 8. | a material requirement planning system,* |
| 9. | process management systems, |
| 10. | project management systems, |
| 11. | a risk management information system, |
| 12. | a strategic planning system, and |
| 13. | a supply chain management system |

*all 3 applications are usually bundled within an erp system

Many if not all of these new systems and upgraded traditional systems listed in Tables 1 and 2 also include the ability to calculate trends, identify performance indicators and determine the parameters that would optimize the element, process, option or risk that is being “managed”. While each of these systems and their analytical extensions may have some value to some subset of the people in each organization, the usefulness of these systems to each organization as a whole is extremely limited for a variety of reasons. The first major limitation is a product of the fact that each of the systems listed in Table 1 is limited to processing the data associated with the element, option, process or risk they are being used to manage. As a result, each system is in effect an un-connected island of information. This has two impacts. First, these systems do not have any direct insight in to the best course of action from an enterprise perspective. Second, they can not take in to account the interaction between different elements, processes, options and risk. As a result, the theoretical benefits that arise from managing and “optimizing” these subsets are not clearly related to producing benefits for the enterprise or organization. In fact, the opposite may be true as unintended consequences and overlooked relationships can turn out to be more important than the theoretical benefits of following the course of action recommended by one of these systems. An example of the problem that overlooked information can create for an organization would be when the customer relationship management system recommends the increase in purchase of an item for a favored customer that comes from the lowest quality, highest cost supplier. Even if the product can be obtained, the poor quality of the product is likely to antagonize a favored customer and the high-cost is likely to produce little profit. Along the same lines, money may be spent to hedge commodity risk while exposure to greater risks from environmental damage may go unexamined and unprotected.

Given the preceding discussion, it should come as no surprise that corporations are not realizing much benefit from installing systems like those listed in Table 1. A leading market research firm recently noted that very few firms are reporting successful customer relationship management projects, though there is definitely a need for systems to improve customer services and retain existing clients. Another market research firm reported failure rates approaching 80% for customer relationship management systems. Similar failure rates have been reported for balanced scorecard systems and visitor management systems.

The second major limitation of all of the systems listed in Table 1 is that they are exclusively focused on only one segment of enterprise value. As a result, they ignore the value that an enterprise or multi-enterprise organization can create within the other four segments of value by effective management of the element, option, process or risk being analyzed. More specifically, most of the systems listed in Table 1 are focused on the current operation segment of value while ignoring the other four segments of business market value—real options, derivatives, excess financial assets and market sentiment. In some cases, the focus on the current operation segment of value is justified. However, in many cases the greater part of the market value impact from effective management of an element, option, process or risk is overlooked when the other segments of value are ignored.

The third major limitation of the systems listed in Table 1 and Table 2 is that they have a piecemeal approach to risk analysis. More specifically, none of the systems listed in the two tables can complete an integrated analysis of all four major classes of risk facing an enterprise: element variability risk, external factor variability risk, event risk, and market risk. In a similar fashion, most event risk analyses are limited to analyzing the impact of natural disasters, weather and accidents while ignoring far greater potential damage from events caused by competitor actions and customer defection. This limitation extends to all known attempts to manage specific risks and all known attempts to manage enterprise risk. The problem with this is that some risks are analyzed in detail while other risks—which may be more significant—are ignored.

The fourth major limitation of the systems listed in Table 1 and Table 2 is that they do not in any way address the inter-relationship between the return from the elements and options within the enterprise and the risks facing the enterprise. This is a critical oversight since the Capital Asset Pricing Model established many years ago that the market value of enterprise equity is at least in part a function of the risk and return associated with the enterprise. Advances in game-theoretic capital asset pricing models have only strengthened this argument in recent months.

A closely related limitation of even the most advanced enterprise risk and enterprise financial management systems is that they do not provide any information about expected value given the risks facing the enterprise or organization. By way of contrast, stock market portfolio analysis systems are used to guide investment managers to reasonable expectations regarding expected returns given the riskiness of their portfolio. The efficient frontier in modern portfolio theory is defined by the maximum expected return for every level of portfolio risk. A system capable of identifying the efficient frontier for managing a corporate portfolio of assets, options and risks would alleviate this problem.

Displacing the narrowly focused systems listed in Tables I and 2 with systems that are capable of developing and/or using the enterprise perspective for analysis and decision making will be greatly facilitated by providing a systematic way for each application to receive the information it needs to provide meaningful recommendations from the enterprise or multi-enterprise organization perspective (or the perspective from a frame within either of these entities). Providing this information in a systematic way would also greatly facilitate collaboration with business partners and outside vendors. While it would be possible to enable narrow systems, systems from partners and systems from vendors by allowing them to download or extract the information regarding the market value matrix, the efficient frontier, liquidity and the statistical relationship between different elements of the matrix of value as detailed in application Ser. No. 10/046,316 filed Jan. 16, 2002, this is not a very efficient or viable long term solution. The grouping of market value matrix, efficient frontier, liquidity and statistical information will hereinafter be referred to as the market value matrix package.

XML and web services that are widely touted as panaceas for system integration problems are also not viable solutions for this problem because they only provide descriptive information (i.e. these are purchase orders from vendor xyz) and/or define procedures for handling expected information (i.e. check the purchase order against the customers credit limit). They do not provide the contextual information needed to make informed management analysis and decisions.

A more effective, long term solution would be to provide a layer within an operating system that defines the business context for the enterprise. Each system would then get the business perspective it required for effective operation by “plugging” in to the layer. In that way, every narrow system would be able to provide recommendations that would benefit the enterprise or multi-enterprise organization instead of the narrow slice of the organization they currently focus on. Enterprise partners would be able to independently make decisions that are in the best interest of the partnership by using the market value matrix package for the multi-enterprise organization defined by their partnership when they evaluate decisions.

Adding an operating system layer for business context will also greatly facilitate collaboration with vendors as they would be able to tailor their proposals to provide the most value to the enterprise they are seeking to sell products and/or services to. This would be particularly true for a financial service company that is seeking to provide a customized financial product to an enterprise and/or to develop a financial product (such as a security) using enterprise specific information. The information in the layer can also be used by vendors of other products and services—in some cases other information such as supply chain status may need to be included along with the market value matrix package for this to work effectively. This functionality will prove to be particularly valuable to companies that are finding innovative ways to form relationships with companies on parameters other than the traditional price, quality and delivery metrics. For example, some companies are sharing the risks associated with completing an assignment with their customers. Other companies are providing innovative financing to their customers by sharing the costs and benefits associated with development of a new product or service. In either case, facilitating the access of vendors to a detailed picture of the business context for an enterprise would contribute to this trend and provide vendors and their customers with new ways to interact and add value to each others operation.

Because almost every enterprise has more than one operating system being used within it, it would be best if the business context layer could be added to a variety of operating systems including the operating systems for computer hardware and other electronic devices, network operating systems, middleware, portals and web service platforms. By providing the information needed to make truly beneficial business decisions to every system that plugs in to one of these networks, the business context layer enables an almost instant “virtual integration” between different parts of an enterprise, between an enterprise and its partners and between and enterprise and the vendors that support it.

Operating in this mode, the project, process and risk optimization systems described previously in cross referenced application Ser. No. 10/036,522 filed Jan. 7, 2002, Ser. No. 10/025,794 filed Dec. 26, 2001, and Ser. No. 10/013,375 filed Dec. 12, 2001 could be used by outside partners and vendors to optimize their proposals for providing products and/or services to the enterprise. The enterprise could also empower its vendors to provide products and/or services recommended by systems of this type in an automated fashion.

In light of the preceding discussion, it is clear that it would be desirable to have an operating system layer that provides the information that narrowly focused systems listed in Tables 1 and 2 (hereinafter, the narrow systems), partner systems and vendor systems require to be able to provide information, products and/or services that are optimized for the enterprise. Ideally, the business context layer would be integrated within a variety of operating systems including a network operating system, a computer hardware operating system and a web services platform.

### SUMMARY OF THE INVENTION

It is a general object of the present invention to provide a novel and useful system for creating a business context layer for one or more operating systems within an enterprise that overcome the limitations and drawbacks of the existing art that were described previously.

A preferable object to which the present invention is applied is enhancing the effectiveness and enabling the virtual integration of disparate enterprise applications, partner applications and vendor applications by:

1. providing an operating system layer for applications, partners and vendors to plug in to as required to obtain complete a three-hundred-sixty degree (360°) view of the value, risks, liquidity and structure of an enterprise under a variety of scenarios (based on the market value matrix package information found in enterprise Value Map™ System databases);

2. providing different market value matrix packages (aka frames) of the organization within the layer for each of the different types of systems that will be interfacing with the layer—for example, internal users may get one frame, partners another frame based on a combined market value matrix and vendors a third view based on the subset of financial information the enterprise user wants to share; and

3. providing a systematic method for tagging information from applications that cannot process market value matrix package information to enable processing by a central Value Map™ System.

Because the typical enterprise uses many operating systems, the system of the present invention propagates the business context layer to many different operating systems including network operating systems, portals, middleware, enterprise application integration applications, operating systems for computers (i.e. Linux, Windows, Mac OSX, etc.), operating systems for other electronic hardware (Palm OS, Windows CE, etc.) and web service platforms. An implementation of the business context layer in a network operating system is shown in FIG. 7 (FIG. 6 shows the Open System Interconnection Model for a network operating system). An implementation of the business context layer in a hardware operating system is shown in FIG. 9 (FIG. 8 shows a typical operating system). An implementation of the business context layer in a web services platform is shown in FIG. 11 (FIG. 10 shows a typical web services platform without the business context layer).

The system of the present invention is capable of functioning without receiving the complete three-hundred-sixty degree (360°) view of the value and risk from an enterprise. However, it does require value and risk data that has been prepared in a uniform fashion. In the preferred embodiment, the complete market value matrix package is used in developing the business context layer.

Before going too much further we need to define the terms layer, operating system and frame in more detail. A layer is software and/or information that gives an application or layer the ability to interact with another layer, application or set of information at a general or abstract level rather than at a detailed level. In this case, the business context layer provides narrow systems and other applications with independence from differences in business context by systematically providing the information needed to define the market value matrix package. The market value matrix package alone or together with other information such as supply chain status or order backlog defines business context. While the business context layer functionality is contained within a single layer in the preferred embodiment, the functionality could also be distributed to more than one layer. An operating system is a program that manages: hardware, other programs, web services, and/or the interaction between any combination of hardware, other programs and web services. For example, a computer operating system manages all the other programs in a computer. In a similar fashion, a network operating system manages the interaction with hardware and applications on a network. The programs and/or hardware make use of the operating system by making requests for services through defined procedures. In addition, users can interact directly with the operating system through a user interface such as a command language or a graphical user interface. Frames are sub-sets of an enterprise, sub-sets of a multi-enterprise organization, enterprise combinations or organization combinations that can be analyzed separately. For example, one frame could group together all the elements, external factors and other risks from the market value matrix package by process allowing different processes to be analyzed by outside vendors. Another frame could exclude the market sentiment segment of value from each enterprise within a multi-enterprise organization. In any event, the user is free to define the frames needed to support informed analysis and decision making by partners, vendors and users across the enterprise.

The business context layer provides narrow systems, vendor systems and partner systems the market value matrix package for the organization as detailed in cross-referenced application Ser. No. 10/046,316 dated Jan. 16, 2002 for each frame defined by the user. Access to the information for each frame is controlled by the security scheme for the layer. Systems using this information would include the systems described previously in cross referenced application Ser. No. 10/036,522 filed Jan. 7, 2002, Ser. No. 10/025,794 filed Dec. 26, 2001, and Ser. No. 10/013,375 filed Dec. 12, 2001.

For narrow systems that do not have the ability to process the market value matrix package information, the business context layer provides an automated guide or wizard that helps steer the user through the process of tagging the narrow system data. The narrow system data is tagged to facilitate processing by the enterprise Value Map™ System in accordance with the matrix cell, feature and processing level schema detailed in cross-referenced application Ser. No. 10/046,316 dated Jan. 16, 2002.

The present invention has the added benefit of eliminating a great deal of time-consuming and expensive effort by automating the delivery of information that is usually derived only after extracting and processing data from the databases, tables, and files from internal systems, external databases and the Internet. In accordance with the invention, the automated extraction, aggregation and analysis of data from a variety of existing computer-based systems significantly increases the scale, scope and timeliness of the analysis and simulation that can be completed in a cost-effective manner.

The method for integrating the numerous, narrow business management systems provided by the present invention eliminates the need for custom interface development. Most importantly the system of the present invention is capable of virtually integrating all of the narrow systems, partner systems and vendor systems in to an overall system for measuring and optimizing organizational financial performance. The level of integration enabled by the system of the present invention will also support: the creation of new product bundles; the creation of new financial services; the automated delivery of new products and services; the automated delivery of traditional financial products and services; and the integration of narrow systems with other applications.

By providing real-time financial context to users of every organization system, every partner system and every vendor system, the business context layer enables the continuous optimization of management decision making across an entire extended multi-enterprise organization.

### BRIEF DESCRIPTION OF DRAWINGS

These and other objects, features and advantages of the present invention will be more readily apparent from the following description of the preferred embodiment of the invention in which:

FIG. 1 is a block diagram showing the major processing steps of the present invention;

FIG. 2 is a diagram showing the files or tables in the application database (50) of the present invention that are utilized for data storage and retrieval during the processing in the business context layer development;

FIG. 3 is a block diagram of an implementation of the present invention;

FIG. 4 is a diagram showing the data windows that are used for receiving information from and transmitting information to the user (20) during system processing;

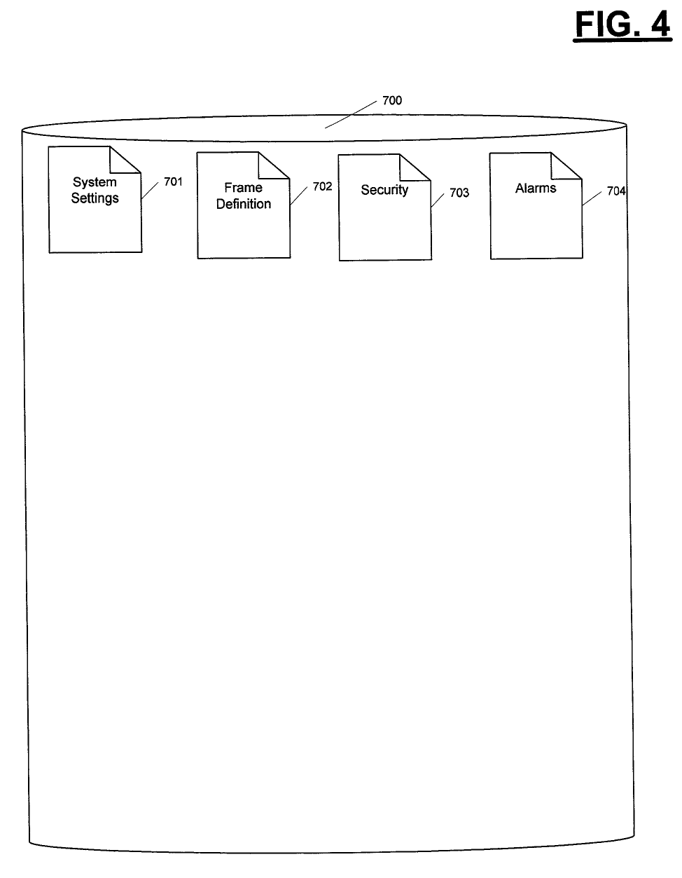

FIG. 5 is a block diagram showing the sequence of steps in the present invention used for specifying system settings, defining security, identifying frames, extracting aggregate, store and manipulate information utilized in system processing from: user input, the external database, the Client Value Map™ System database and the Internet;

FIG. 6 is a diagram showing the layers in the Open System Interconnection Model for networking;

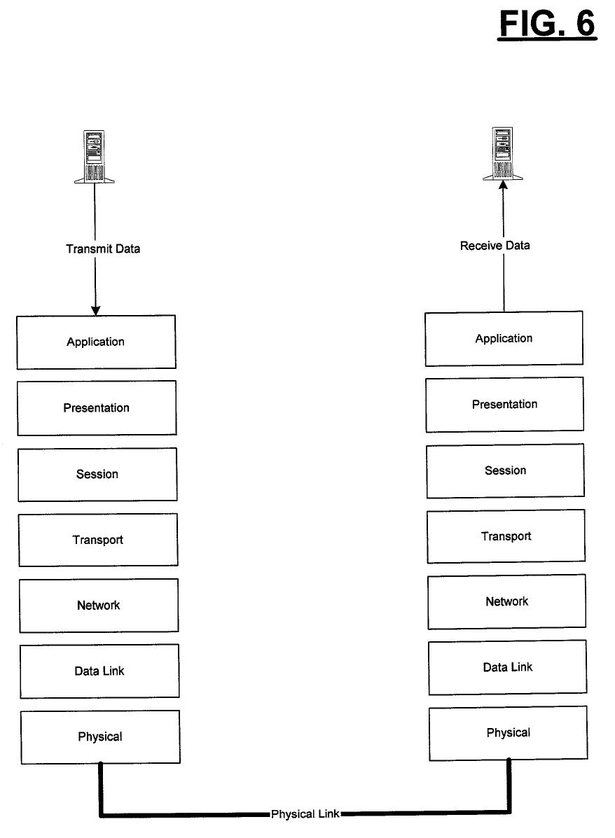

FIG. 7 a diagram showing the layers in a network operating system with a business context layer;

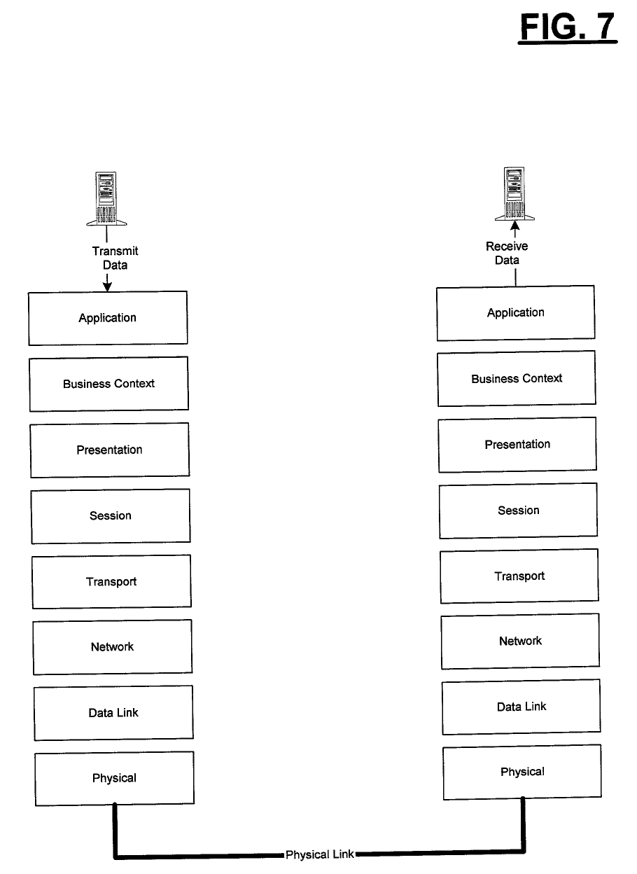

FIG. 8 is a diagram showing the layers in a hardware operating system;

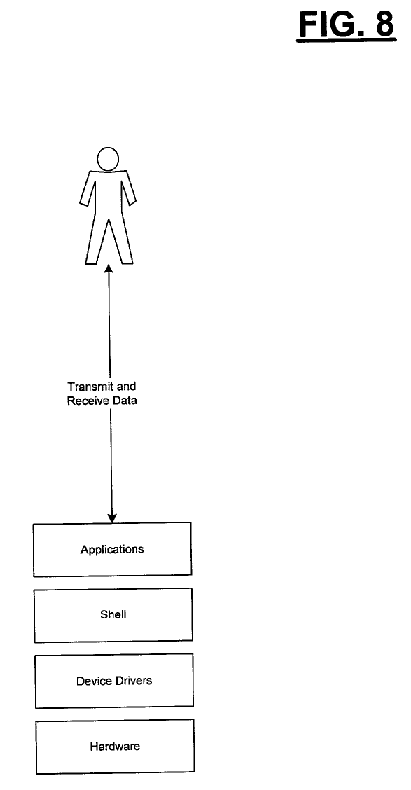

FIG. 9 a diagram showing the layers in a hardware operating system with a business context layer;

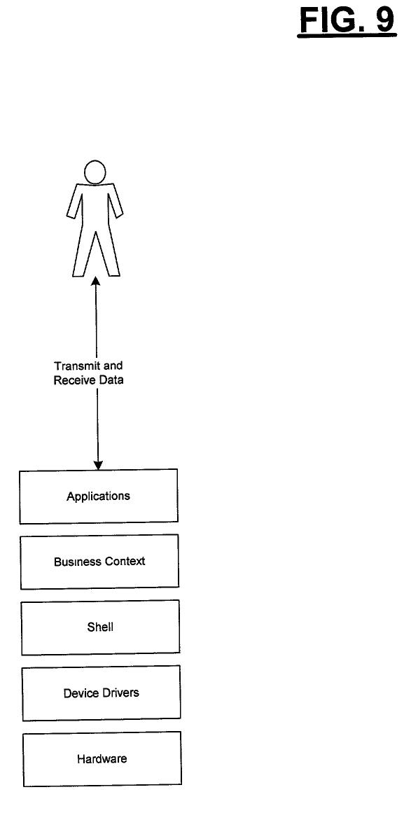

FIG. 10 is a diagram showing the layers in a web services platform;

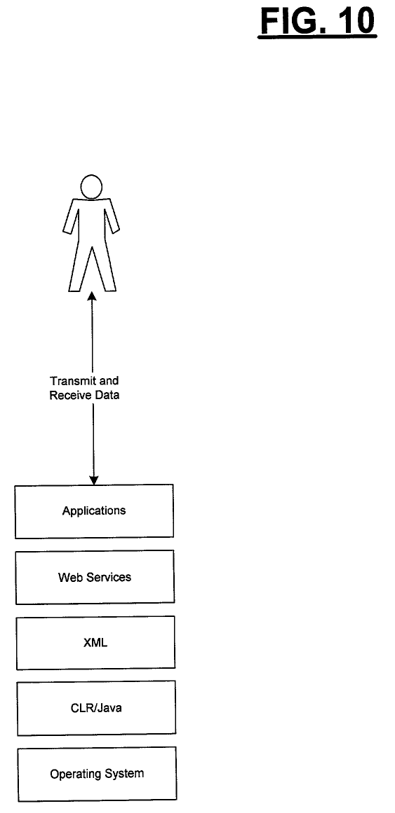

FIG. 11 a diagram showing the layers in a web services platform with a business context layer; and

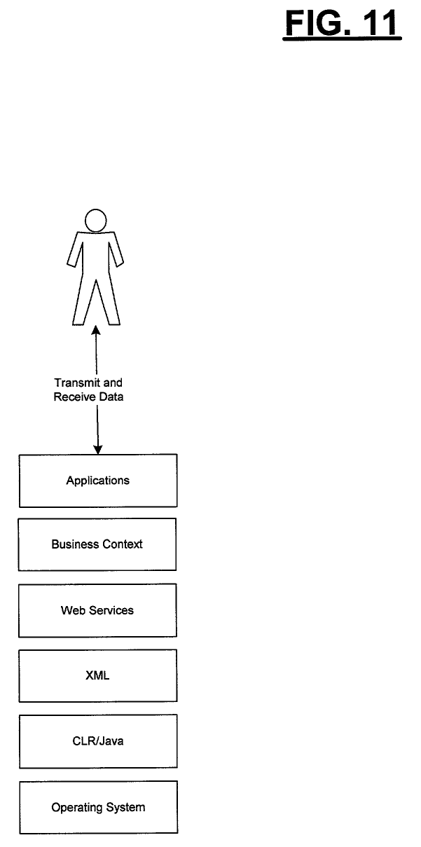

FIG. 12 is a diagram showing enterprise market value matrices being combined to calculate the market value matrix for an organization.

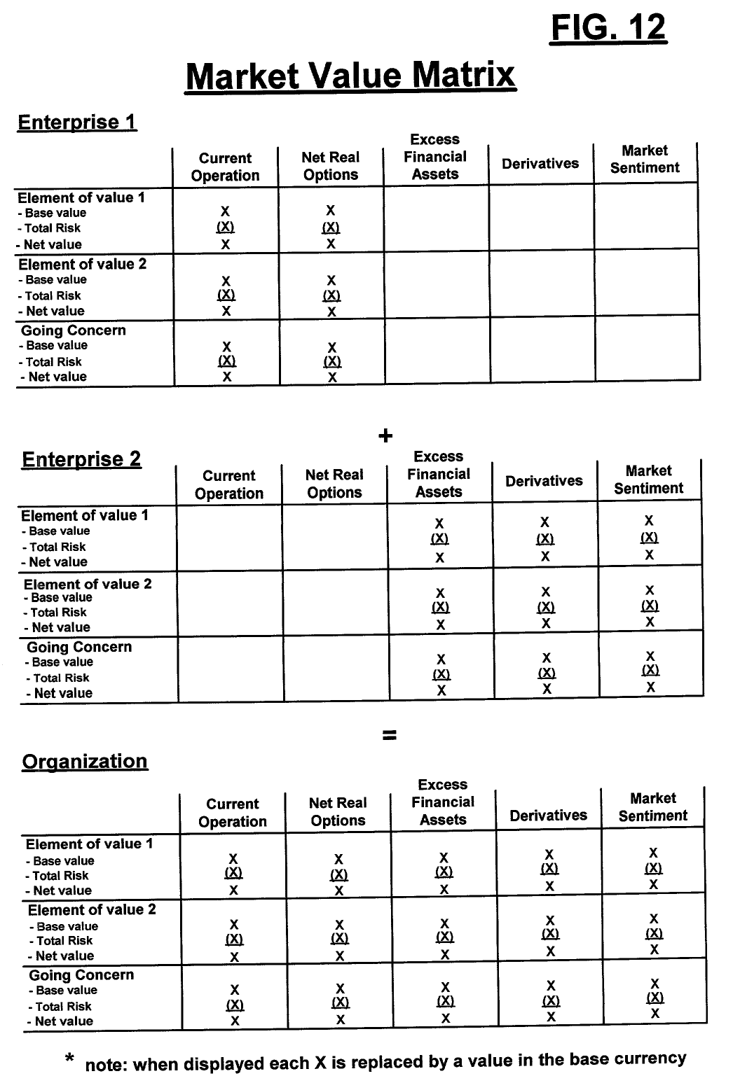

### DETAILED DESCRIPTION OF THE PREFERRED EMBODIMENT

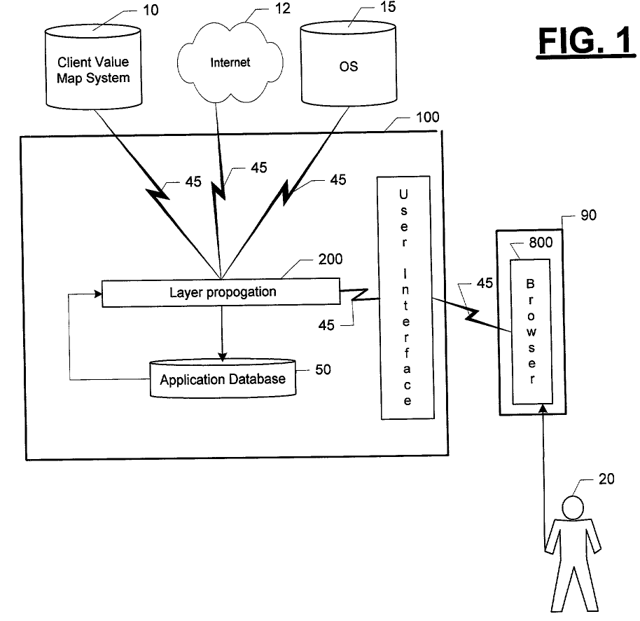

FIG. 1 provides an overview of the processing completed by the business context layer propagation system. In accordance with the present invention, a method of and system (100) for business context layer development and deployment is provided. Processing starts in this system (100) with the specification of system settings, the specification of security settings, the specification of the frames that will be included in the layer, the specification of alarms, the extraction of data and the propagation of the layer to an operating system (15). Information is extracted via a network (45) from a Value Map™ System database (30). While only one Value Map™ System database (10) is shown, the system (100) can communicate with a number Value Map™ Systems as part of its normal operation. In a similar manner, while only one operating system (15) is shown, the system is capable of propagating a business context layer to a number of operating systems. The system specification and the information extractions may be influenced by an user (20) through interaction with a user-interface portion of the application software (700) that mediates the display, transmission and receipt of all information to and from browser software (800) such as the Microsoft Internet Explorer or Netscape Navigator in an access device (90) such as a phone or personal computer that the user (20) interacts with. It should be understood that it is possible to use peer-to-peer networking to complete the data transfer. It is also possible to complete a bulk extraction of data from the database (10) via the network (45) using data extraction applications before initializing the data bots. The data extracted in bulk could be stored in a single datamart or data warehouse where the data bots could operate on the aggregated data.

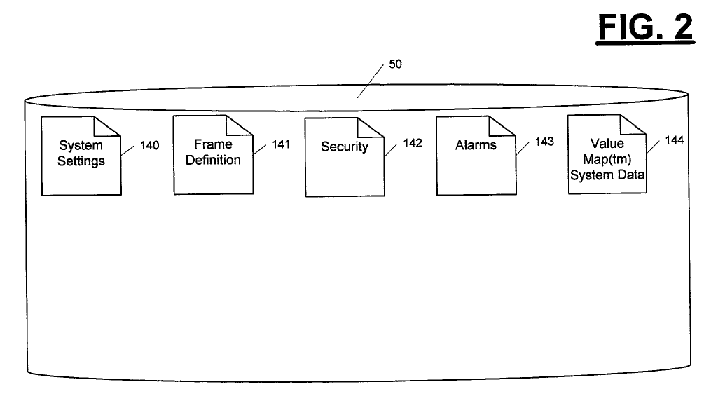

All extracted information is stored in a file or table (hereinafter, table) within an application database (50) as shown in FIG. 2. The application database (50) contains tables for storing user input, extracted information and system calculations including a system settings table (140), a frame definition table (141), a security table (142), an alarms table (143) and a Value Map™ System table (144). The application database (50) can optionally exist as a datamart, data warehouse or departmental warehouse. The system of the present invention has the ability to accept and store supplemental or primary data directly from user input, a data warehouse or other electronic files in addition to receiving data from the databases described previously. The system of the present invention also has the ability to complete the necessary processing without receiving complete data from the specified database. However, in the preferred embodiment all required information is obtained from the specified data source (10).

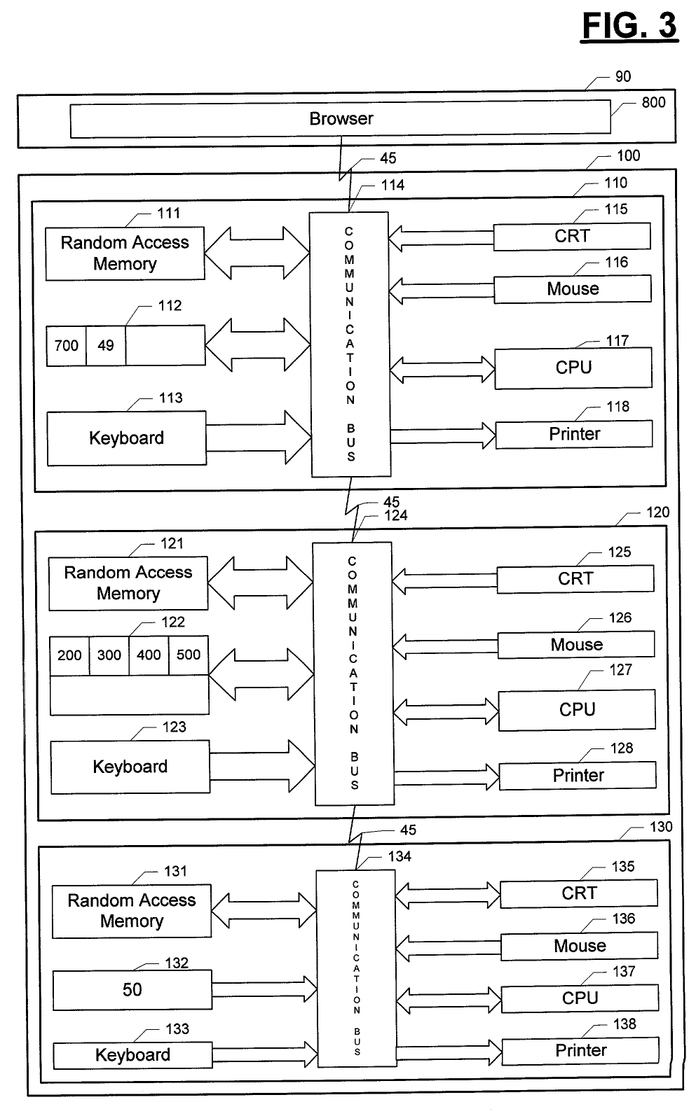

As shown in FIG. 3, the preferred embodiment of the present invention is a computer system (100) illustratively comprised of a user-interface personal computer (110) connected to an application-server personal computer (120) via a network (45). The application server personal computer (120) is in turn connected via the network (45) to a database-server personal computer (130). The user interface personal computer (110) is also connected via the network (45) to an Internet browser appliance (90) that contains browser software (800) such as Microsoft Internet Explorer or Netscape Navigator.

The database-server personal computer (130) has a read/write random access memory (131), a hard drive (132) for storage of the application database (50), a keyboard (133), a communications bus (134), a display (135), a mouse (136), a CPU (137) and a printer (138).

The application-server personal computer (120) has a read/write random access memory (121), a hard drive (122) for storage of the non-user-interface portion of the application software (200, 300 and 400) of the present invention, a keyboard (123), a communications bus (124), a display (125), a mouse (126), a CPU (127) and a printer (128). While only one client personal computer is shown in FIG. 3, it is to be understood that the application-server personal computer (120) can be networked to fifty or more client personal computers (110) via the network (45). The application-server personal computer (120) can also be networked to fifty or more server, personal computers (130) via the network (45). It is to be understood that the diagram of FIG. 3 is merely illustrative of one embodiment of the present invention.

The user-interface personal computer (110) has a read/write random access memory (111), a hard drive (112) for storage of a client data-base (49) and the user-interface portion of the application software (700), a keyboard (113), a communications bus (114), a display (115), a mouse (116), a CPU (117) and a printer (118).

The application software (200 and 700) controls the performance of the central processing unit (127) as it completes the calculations required to support the business layer propagation. In the embodiment illustrated herein, the application software program (200 and 700) is written in a combination of C++, Java and Visual Basic®. The application software (200 and 700) can use Structured Query Language (SQL) for extracting data from the databases and the Internet (25 and 30). The user (20) can optionally interact with the user-interface portion of the application software (700) using the browser software (800) in the browser appliance (90) to provide information to the application software (200 and 700) for use in determining which data will be extracted and transferred to the application database (50) by the data bots.

User input is initially saved to the client database (49) before being transmitted to the communication bus (124) and on to the hard drive (122) of the application-server computer via the network (45). Following the program instructions of the application software, the central processing unit (127) accesses the extracted data and user input by retrieving it from the hard drive (122) using the random access memory (121) as computation workspace in a manner that is well known.

The computers (110, 120 and 130) shown in FIG. 3 illustratively are personal computers or any of the more powerful computers or workstations that are widely available. Typical memory configurations for client personal computers (110) used with the present invention should include at least 1024 megabytes of semiconductor random access memory (111) and at least a 250 gigabyte hard drive (112). Typical memory configurations for the application-server personal computer (120) used with the present invention should include at least 2056 megabytes of semiconductor random access memory (121) and at least a 500 gigabyte hard drive (122). Typical memory configurations for the database-server personal computer (130) used with the present invention should include at least 5112 megabytes of semiconductor random access memory (131) and at least a 500 gigabyte hard drive (132).

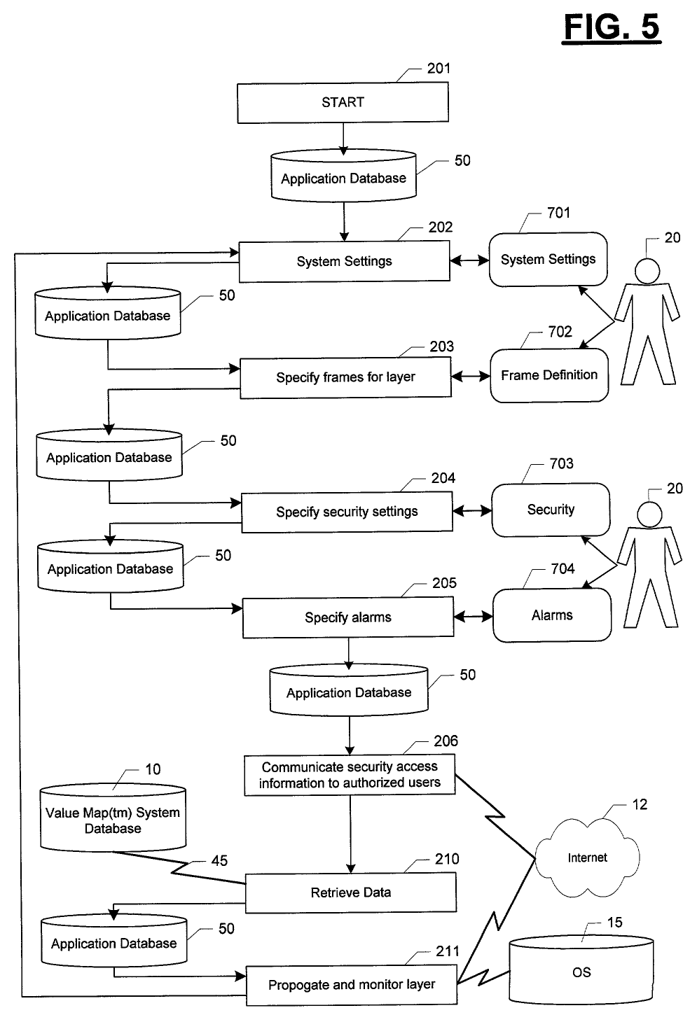

Using the system described above, a business context layer developed and propagated for each frame within enterprise or multi-enterprise organization defined by the user. The business context layer propagation is completed in one stage of processing. As shown in FIG. 5 the first stage of processing (block 200 from FIG. 1) user.

### Layer Propagation

The flow diagrams in FIG. 5 detail the processing that is completed by the portion of the application software (200) that extracts, aggregates, transforms and stores the information required for business context layer propagation from: user input and the Value Map™ System database (10). The Value Map™ System databases contain the: market value matrix (which can be subdivided into the matrix of value and the matrix of risk), liquidity status, statistics and efficient frontier information for a variety of scenarios by frame as detailed in cross-referenced application Ser. No. 10/046,316 filed Jan. 16, 2002 the disclosure of which is incorporated herein by reference.

System processing starts in a block 201, FIG. 5, which immediately passes processing to a software block 202. The software in block 202 prompts the user (20) via the system settings data window (701) to provide system setting information. The system setting information entered by the user (20) is transmitted via the network (45) back to the application server (120) where it is stored in the system settings table (140) in the application database (50) in a manner that is well known. The specific inputs the user (20) is asked to provide at this point in processing are shown in Table 1.

TABLE 1

| | |
|---|---|
| 1. | Frequency of updates? (hourly, daily, weekly, monthly or quarterly) |
| 2. | Location of Value Map ™ System databases and metadata |
| | Security options |
| 3. | Operating Systems that will have business context layers (definition |
| | and location) |
| 4. | Security Method (Kerberos or IPSEC) |

After the storage of system setting data is complete, processing advances to a software block 203.

The software in block 203 prompts the user (20) via the frame definition window (702) to select the frames that will be propagated to each operating system. For example, the user (20) could choose to The inputs from the user (20) are stored in the frame definition table (141) in the application database (50). When the storage of frame definitions is complete, then processing advances to a software block 204.

The software in block 204 prompts the user (20) via the security window (703) to designate who will be authorized to access each frame of the Business Context Layer by operating system. The user (20) stores the name, frame and email address of each authorized user. The user (20) also designates which authorized users/systems are capable of processing the business context information. Authorized users and systems that cannot process the business context information will be sent an applet to help them tag their data as required to directly interface with the Value Map™ System as described previously in cross-referenced application Ser. No. 10/046,316 filed Jan. 16, 2002. The inputs from the user (20) are stored in the security table (142) in the application database (50). When the storage of the security information is complete, then processing advances to a software block 205.

The software in block 205 prompts the user (20) via the alarm window (704) to designate alarms that should be sent to any or all of the authorized users that were established in the prior stage of processing. The alarms can be based on fairly traditional alarm settings such as sales above or below a certain level over a certain time period and inventory shortages. The user (20) also has the option of using the comprehensive picture of business context provided by the market value matrix to set more sophisticated alarm settings such as market sentiment has turned negative or customer acquisition process variability has increased above a certain level. The inputs from the user (20) are stored in the alarms table (143) in the application database (50). When the storage of alarms is complete, then processing advances to a software block 206.

The software in block 206 communicates the security access information to each authorized user using an encrypted email sent via the Internet (12) before processing advances to a software block 210. The software in block 210 activates data bots to extract the required business context information from the Value Map™ System database (10). Bots are independent components of the application that have specific tasks to perform. In the case of data bots, their primary task is to extract and store Value Map™ System data. Each data bot initialized by software block 221 will store its data in the Value Map™ System table (144). Every data bot activated in this stage contains the information shown in Table 2.

TABLE 2

| | |
|---|---|
| 1. | Unique ID number (based on date, hour, minute, second of creation) |
| 2. | The data source location |
| 3. | Mapping information |
| 4. | Timing of extraction |
| 5. | Enterprise |
| 6. | Storage Location (to allow for tracking of source and destination |
| | events) |
| 7. | Creation date (date, hour, minute, second) |

The data bot extracts and stores data in the Value Map™ System table (144) in accordance with the frequency specified by the user (20) in the system settings table (140) before processing advances to a software block 211.

The software in block 211 propagates the layer access information over a network (45) to the designated operating system(s) (15) and monitors the extracted information in the Value Map™ System table (144) to see if any of the alarm settings have been exceeded. When an alarm setting has been exceeded, then the software in block 211 sends an encrypted email message to the authorized user via the Internet (12). When authorized users connect to the layer and provide the proper access information the software in block 211 establishes an L2TP connection and transmits the business context information or the data conversion applet using the designated security protocols. The cycle described above is repeated continuously as required to support the continuous optimization of business performance.

Thus, the reader will see that the method and system described above transforms business context information in to an operating system layer that empowers enterprise systems, partners and vendors to continually develop information, products and services and to make decisions that support the overall financial goals of an enterprise or a multi-enterprise organization. In addition to improving their ability to manage their operations, the system of the present invention will enable the development of entire new classes of products and services that blur the line between vendor and customer without losing control or independence.

While the above description contains many specificity's, these should not be construed as limitations on the scope of the invention, but rather as an exemplification of one preferred embodiment thereof. Accordingly, the scope of the invention should be determined not by the embodiment illustrated, but by the appended claims and their legal equivalents.

1. An operation integration method, comprising
integrating organization related data in accordance with a common schema;
creating a market value matrix package using at least a portion of said data; and
making the at least part of the package information available to other systems via an operating system to support organization processing.

2. The method of claim 1 where the operating system is a network operating system, portal, hardware operating system, middleware application or web services environment.

3. The method of claim 2 that further comprises making the package information available using one or more operating system layers, one or more web services or combinations thereof.

4. The method of claim 1 that further comprises:
dividing the market value matrix package into one or more frames, and
making each of one or more frames available via an operating system.

5. The method of claim 4 where the frames include one or more partner frames, one or more vendor frames, one or more internal user frames and combinations thereof.

6. The method of claim 1 where the value matrix package contains information from the group consisting of the market value matrix, efficient frontier, liquidity status, element statistics, supply chain status, customer order status, development status and combinations thereof.

7. The method of claim 6 where the where one axis of the market value matrix is defined by the segments of value present in the organization and the other axis is defined by the elements of value, external factors and risks that are causal to changes in organization financial performance.

8. The method of claim 7 where the segments of value are selected from the group consisting of current operation, real options, investments, derivatives, market sentiment and combinations thereof.

9. The method of claim 7 where the elements of value are selected from the group consisting of alliances, brands, channels, content, customers, customer relationships, employees, employee relationships, information technology, intellectual property, knowledge, partnerships, processes, production equipment, products, technology, vendors, vendor relationships and combinations thereof.

10. The method of claim 7 where external factors are numerical indicators of conditions external to the organization, numerical indications of prices external to the organization, numerical indications of organization conditions compared to external expectations of organization condition, numerical indications of the organization performance compared to external expectations of organization performance and combinations thereof.

11. The method of claim 7 where the risks are selected from the group consisting of event risks, factor variability risks, element variability risks, market variability risks, strategic risks and contingent liabilities.

12. The method of claim 1 where organization related data are obtained from the group consisting of advanced financial systems, asset management systems, basic financial systems, alliance management systems, brand management systems, customer relationship management systems, channel management systems, estimating systems, intellectual property management systems, process management systems, supply chain management systems, vendor management systems, operation management systems, enterprise resource planning systems (ERP), material requirement planning systems (MRP), quality control systems, sales management systems, human resource systems, accounts receivable systems, accounts payable systems, capital asset systems, inventory systems, invoicing systems, payroll systems, purchasing systems, web site systems, financial service provider systems, IT asset management systems, business intelligence systems, call management systems, channel management systems, content management systems, demand chain systems, email management systems, employee relationship management systems, energy risk management systems, fraud management systems, incentive management systems, innovation management systems, investor relationship management systems, knowledge management systems, location management systems, maintenance management systems, partner relationship management systems, performance management systems (for IT assets), price optimization systems, private exchanges, product life-cycle management systems, project portfolio management systems, risk simulation systems, sales force automation systems, scorecard systems, service management systems, six-sigma quality management systems, support chain systems, technology chain systems, unstructured data management systems, weather risk management systems, workforce management systems, yield management systems, user input, external databases, the Internet and combinations thereof.

13. The method of claim 1 where an organization is a single product, a group of products, a division, an entire company, a multi company corporation, a value chain or a collaboration.

14. A computer readable medium having sequences of instructions stored therein, which when executed cause the processors in a plurality of computers that have been connected via a network to perform an organization optimization method, comprising:
aggregating organization narrow system data in accordance with a common schema;
creating a market value matrix using at least a portion of the data; and
making the market value matrix available for use in identifying changes that will optimize one or more aspects of organization financial performance.

15. The computer readable medium of claim 14 where the common schema is a self descriptive schema that includes xml metadata, a data structure and a data dictionary.

16. The computer readable medium of claim 15 where the data dictionary defines common attributes from the group consisting of account numbers, components of value, currencies, derived data types, elements of value, external factors, risks, segments of value, time periods, units of measure and combinations thereof.

17. The computer readable medium of claim 15 where the data structure is the market value matrix for the organization where one axis of the market value matrix is defined by the segments of value present in the organization and the other axis is defined by the elements of value, external factors and risks that are causal to changes in organization financial performance.

18. The computer readable medium of claim 17 where the segments of value are selected from the group consisting of current operation, real options, investments, derivatives, market sentiment and combinations thereof.

19. The computer readable medium of claim 17 where the elements of value are selected from the group consisting of alliances, brands, channels, content, customers, customer relationships, employees, employee relationships, information technology, intellectual property, knowledge, partnerships, processes, production equipment, products, technology, vendors and vendor relationships.

20. The computer readable medium of claim 17 where external factors are numerical indicators of conditions external to the organization, numerical indications of prices external to the organization, numerical indications of organization conditions compared to external expectations of organization condition, numerical indications of the organization performance compared to external expectations of organization performance and combinations thereof.

21. The computer readable medium of claim 17 where the risks are selected from the group consisting of event risks, factor variability risks, element variability risks, market variability risks, strategic risks, contingent liabilities and combinations thereof.

22. The computer readable medium of claim 14 wherein the narrow systems are advanced financial systems, asset management systems, basic financial systems, alliance management systems, brand management systems, customer relationship management systems, channel management systems, estimating systems, intellectual property management systems, process management systems, supply chain management systems, vendor management systems, operation management systems, enterprise resource planning systems (ERP), material requirement planning systems (MRP), quality control systems, sales management systems, human resource systems, accounts receivable systems, accounts payable systems, capital asset systems, inventory systems, invoicing systems, payroll systems, purchasing systems, web site systems, financial service provider systems, IT asset management systems, business intelligence systems, call management systems, channel management systems, content management systems, demand chain systems, email management systems, employee relationship management systems, energy risk management systems, fraud management systems, incentive management systems, innovation management systems, investor relationship management systems, knowledge management systems, location management systems, maintenance management systems, partner relationship management systems, performance management systems (for IT assets), price optimization systems, private exchanges, product life-cycle management systems, project portfolio management systems, risk simulation systems, sales force automation systems, scorecard systems, service management systems, six-sigma quality management systems, support chain systems, technology chain systems, unstructured data management systems, weather risk management systems, workforce management systems, yield management systems and combinations thereof.

23. The computer readable medium of claim 14 where the data includes historical data, forecast data and combinations thereof.

24. The computer readable medium of claim 14 where the data includes transaction data, descriptive data, geospatial data, text data, linkage data, derived data and combinations thereof.

25. The computer readable medium of claim 14 where an organization is a single product, a group of products, a division, an entire company, a multi company corporation or a value chain.

26. The computer readable medium of claim 14 that further comprises making the package information available via an operating system.

27. The computer readable medium of claim 26 where the operating system is a network operating system, portal, hardware operating system, middleware application or web services environment.

28. The computer readable medium of claim 27 that further comprises making the market value matrix available using one or more operating system layers, one or more web services or combinations thereof.

29. The computer readable medium of claim 14 that further comprises:
dividing the market value matrix into one or more frames where the frames include one or more partner frames, one or more vendor frames, one or more internal user frames and combinations thereof, and
making each of one or more frames available via an operating system.

30. The computer readable medium of claim 14 where the market value matrix identifies the segments of value present in the organization and the elements of value, external factors and risks that are causal to changes in organization financial performance by segment of value.

31. The computer readable medium of claim 14 where the one or more aspects of financial performance are selected from the group consisting of alliance risk, brand risk, channel risk, content risk, contingent liabilities, customer risk, customer relationship risk, current operation risk, derivative risk, employee risk, employee relationship risk, energy risk, enterprise risk, external factor risk, event risk, fraud risk, information technology risk, intellectual property risk, investment risk, knowledge risk, market sentiment risk, market risk, market volatility, organization risk, partnership risk, process risk, production equipment risk, product risk, real option risk, technology risk, total risk, vendor risk, vendor relationship risk, weather risk, alliance return, brand return, channel return, content return, contingent liabilities, customer return, customer relationship return, current operation return, derivative return, employee return, employee relationship return, enterprise return, external factor return, event return, information technology return, intellectual property return, investment return, knowledge return, market sentiment return, market return, market volatility, organization return, partnership return, process return, production equipment return, product return, real option return, technology return, total return, vendor return, vendor relationship return, alliance value, brand value, channel value, content value, contingent liabilities, customer value, customer relationship value, current operation value, derivative value, employee value, employee relationship value, enterprise value, external factor value, event value, information technology value, intellectual property value, investment value, knowledge value, market sentiment value, market value, market volatility, organization value, partnership value, process value, production equipment value, product value, real option value, technology value, vendor value, vendor relationship value and combinations thereof.

32. A business context layer for a network operating system, portal, hardware operating system or middleware application.

33. The business context layer of claim 32 that quantifies the impact of each element of value, external factor and risk on each of the segments of organization value.

34. The business context layer of claim 33 where the segments of value are selected from the group consisting of current operation, real options, investments, derivatives, market sentiment and combinations thereof.

35. The business context layer of claim 33 where the elements of value are selected from the group consisting of alliances, brands, channels, content, customers, customer relationships, employees, employee relationships, information technology, intellectual property, knowledge, partnerships, processes, production equipment, products, technology, vendors and vendor relationships.

36. The business context layer of claim 33 where external factors are numerical indicators of conditions external to the organization, numerical indications of prices external to the organization, numerical indications of organization conditions compared to external expectations of organization condition, numerical indications of the organization performance compared to external expectations of organization performance and combinations thereof.

37. The business context layer of claim 33 where the risks are selected from the group consisting of event risk, factor variability risk, element variability risk, market variability risk, strategic risk and contingent liabilities.

38. The business context layer of claim 33 that includes frames from the group consisting of partner frames, vendor frames, internal user frames and combinations thereof.
